(19) United States
(12) Patent Application Publication
(10) Pub. No.: US 2025/0214823 A1
(43) Pub. Date: Jul. 3, 2025

(54) ELECTRIC CAN OPENER

(71) Applicant: KITCHEN MAMA LLC, WILMINGTON, DE (US)

(72) Inventors: Shih-Chuan CHUANG, Wilmington, DE (US); Ching-Hsiu YAO, Wilmington, DE (US); Mao-Xi LIU, Wilmington, DE (US)

(73) Assignee: KITCHEN MAMA LLC, WILMINGTON, DE (US)

(21) Appl. No.: 18/595,777

(22) Filed: Mar. 5, 2024

(30) Foreign Application Priority Data
Dec. 29, 2023 (TW) 112214400

(51) Int. Cl. B67B 7/00

(52) U.S. Cl. CPC B67B 7/38

(57) ABSTRACT

An electric can opener includes a bottom shell having an elongated slot, a rotatable shaft reciprocally moveable along the elongated slot, a main gear coaxially mounted to the rotatable shaft, a roller rotatably disposed inside the bottom shell, an engaging gear fixed to the rotatable shaft and located outside the bottom shell, a blade assembly disposed to the bottom shell, and an elastic member for imparting a return force on the rotatable shaft. The main gear has a bottom surface monolithically formed with a cam having a contact surface, with which the roller is rotatably contacted. When the rotatable shaft stays at a ready position, the engaging gear is away from the blade assembly, and when the rotatable shaft stays at an operating position, the engaging gear is close to the blade assembly for clamping a can between a blade edge and the engaging gear.

### BACKGROUND OF THE INVENTION

### 1. Field of the Invention

The present invention relates to openers used for opening containers such as cans and more particularly, to an electric can opener.

### 2. Description of the Related Art

Conventional manual can openers require one hand of the user to grip the can, while the other hand must rotate the handle of the can opener, driving the blade to cut open the can. This process is time-consuming and labor-intensive, making it highly inconvenient.

To address the above-mentioned issues, various types of electric can openers have been developed and widely adopted by consumers. For example, U.S. Pat. Nos. 8,955,227 and 9,630,825 disclose two types of electric can openers. The former can drive the blade assembly towards or away from the engaging gear, while the latter can drive the engaging gear towards or away from the blade assembly. By utilizing the blade edge of the blade assembly to cut into the can and the rotational cooperation between the blade and the engaging gear, the can can be automatically opened. Moreover, after the can has been completely opened, the blade assembly or the engaging gear can automatically return to its initial, ready-to-use position, and then the can openers can automatically cut the power off. While these electric can openers provide convenience not found in manual can openers, the overall structural designs of the electric can openers in the aforesaid patents are quite complex and requires numerous parts and components, resulting in a relatively time-consuming and costly manufacturing and assembly process. Additionally, the fastening screws for the blade assembly in the aforesaid patents are located inside the housing of the can opener, resulting in inconvenience in replacing the blade assembly. In other words, improvements on the conventional electric can openers are still required.

### SUMMARY OF THE INVENTION

The present invention has been accomplished in view of the above-noted circumstances. It is an objective of the present invention to provide an electric can opener, which has a simple structural design such that it can be easily and conveniently manufactured and assembled.

To attain the above objective, the present invention provides an electric can opener comprising a bottom shell, a rotatable shaft, a main gear, a roller, an engaging gear, a blade assembly, and an elastic member. The bottom shell has a bottom plate and an elongated slot penetrating through the bottom plate. The rotatable shaft has a top end portion and a bottom end portion, and the rotatable shaft is inserted through the elongated slot in a way that the rotatable shaft is reciprocally moveable along the elongated slot between a ready position and an operating position, the top end portion is located inside the bottom shell, and the bottom end portion protrudes outside the bottom shell. The main gear is coaxially mounted to the top end portion of the rotatable shaft and drivenable to rotate. The main gear has a bottom surface monolithically formed with a cam having a contact surface in a way that a distance between the contact surface and an axis of the rotatable shaft varies in accordance with locations of the contact surface. The roller is rotatably disposed inside the bottom shell in contact with the contact surface of the cam. The engaging gear is fixed to the bottom end portion of the rotatable shaft. The blade assembly is directly or indirectly disposed to the bottom shell and provided with a blade edge outside the bottom shell. The elastic member is connected with the rotatable shaft to impart a rebounding force on the rotatable shaft for moving the rotatable shaft toward the ready position. When the rotatable shaft stays at the ready position, the engaging gear is away from the blade assembly. When the rotatable shaft stays at the operating position, the engaging gear is close to the blade assembly for clamping a can between the blade edge and the engaging gear.

By the above-described technical features, i.e., by the main gear that is integrally provided with the cam and directly mounted to the rotatable shaft, when the main gear is driven to rotate, because the axis of the roller stays stationary and the roller is in rolling contact with the contact surface of the cam, the distance between the axis of the rotatable shaft and the axis of the roller will vary in accordance with the contact locations on the contact surface to force the rotatable shaft to move from the ready position to the operating position, resulting in that the engaging gear moves closer to the blade to engage with the can lid, and the blade edge cuts into the can lid. At this point, although the elastic member is tensioned, the rebounding force of the elastic member is smaller than the engaging force of the engaging gear, allowing the main gear to continuously rotate so as to drive the engaging gear to cooperate with the blade to completely cut open the can. After the can is fully opened, the engaging force becomes smaller than the rebounding force of the elastic member, such that the rebounding force pushes the rotatable shaft to return from the operating position to the ready position, thereby completing the entire can-opening process. Overall, the electric can opener provided by the present invention has a simpler structure compared to prior arts, achieving the objective that the electric can opener can be easily and conveniently made and assembled.

Preferably, the main gear comprises a circular gear member, the cam monolithically formed with the circular gear member, and an axial hole penetrating through the circular gear member and the cam. The top end portion of the rotatable shaft is fixedly inserted into the axial hole. The cam has an elliptical profile with a long axis and a short axis. The axial hole has an axis, which passes through a center of the circular gear member and is biased towards one side of the short axis. That is, the axial hole and the circular gear member is coaxial, and the axis of the axial hole is offset from the center of the elliptical cam along the short axis of the elliptical cam at a predetermined distance. In this way, a larger stroke, i.e., the difference between the maximum and minimum distances between the rotatable shaft axis and the roller axis, may be provided with small-sized component, allowing the overall volume of the electric can opener of the present invention to be more compact.

Preferably, the cam is formed by a plurality of ribs protruding from a bottom surface of the circular gear member. In this way, the weight of the main gear may be reduced while the required structural strength of the main gear may be maintained.

Preferably, the electric can opener may further comprise a roller mounting plate fixed inside the bottom shell and located between the bottom plate and the main gear. The roller mounting plate has a through hole in communication with the elongated slot of the bottom plate for the rotatable shaft to pass through. The roller is disposed on a top surface of the roller mounting plate. In this way, the roller and the main gear can be vertically arranged, effectively utilizing space, and making assembly easier.

Preferably, the electric can opener may further comprise a power-off switch located by one side of the rotatable shaft in a way that when the rotatable shaft moves from the operating position to the ready position, the rotatable shaft contacts the power-off switch, thereby cutting off a power supplied to the electric can opener. In this way, after completing the can-opening action, the electric can opener can automatically stop without the need of stopping the can opener manually, thereby providing greater convenience.

Another objective of the present invention is to provide an electric can opener, the blade assembly of which can be easily and conveniently assembled and dismantled.

To attain the above objective, the blade assembly may comprise a central axle, a ring blade with the blade edge, a sleeve, and a bottom screw. The central axle has a top end portion directly or indirectly fixed to the bottom plate of the bottom shell, and a bottom end portion protruding outside the bottom plate of the bottom shell. The ring blade and the sleeve are sequentially sleeved onto the central axle from the bottom end portion of the central axle towards the top end portion of the central axle. The bottom screw is screwingly threaded into the bottom end portion of the central axle to tighten up the sleeve. In this way, by disassembling the bottom screw, the sleeve and ring blade can be sequentially removed from the central axle, and a new ring blade can be easily reassembled. As a result, the assembly and disassembly of the blade assembly, as well as the replacement of the ring blade, are very easy.

Preferably, the bottom plate of the bottom shell has a bottom surface provided with an installation recess. The electric can opener may further comprise a blade mounting plate fixedly disposed to the installation recess and provided with a top surface, a bottom surface, an elongated slot corresponding to and communicating with the elongated slot of the bottom plate, and a through hole penetrating through the top and bottom surfaces of the blade mounting plate. The top end portion of the central axle is inserted into the through hole of the blade mounting plate and fixed to the blade mounting plate by a top screw that is screwingly threaded into the top end portion of the central axle and presses against the top surface of the blade mounting plate. In this way, the blade mounting plate provides sufficient structural strength for the installation of the blade assembly, and the central axle can be easily assembled and fixed to the bottom shell via the blade mounting plate.

Preferably, the bottom shell has a working hole penetrating through the bottom plate in a way that the working hole is in communication with the through hole of the blade mounting plate. In this way, a screwdriver may be inserted from a top side of the bottom shell through the working hole to tighten or loosen the top screw, thus securely locking the central axis to the blade mounting plate or disassembling the central axle from the blade mounting plate.

Preferably, the sleeve may be provided at a top portion thereof with a central protruding shaft, onto which the ring blade is sleeved in a way that the ring blade is sandwiched between a top surface of the sleeve and the bottom surface of the blade mounting plate. In this way, the ring blade may be securely positioned and coupled with the sleeve.

Preferably, the blade assembly may comprise a washer sleeved onto the central axle and sandwiched between the bottom screw and the sleeve. The washer has an engagement groove, and the bottom end portion of the central axle has an engagement block engaged in the engagement groove. This ensures that the bottom screw can be securely fastened to the central axle, preventing the bottom screw from loosening due to the vibrations caused by the can-opening action.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will be further illustrated in the following embodiment and the accompanying drawings, and wherein:

FIG. 1 is a perspective assembled view of an electric can opener according to a preferred embodiment of the present invention;

FIG. 2 is an exploded perspective view of the electric can opener of the embodiment of the present invention;

FIG. 3 is a bottom perspective view of a part of the electric can opener of the embodiment of the present invention;

FIG. 4 is a top exploded perspective view, showing the bottom shell and the can cutting structure of the electric can opener of the embodiment of the present invention;

FIG. 5 is a bottom exploded perspective view, showing the bottom shell and the can cutting structure of the electric can opener of the embodiment of the present invention;

FIG. 6 is an exploded perspective view, showing the main gear and the roller mounting plate of the electric can opener of the embodiment of the present invention;

FIG. 7a is a bottom perspective view of the main gear of the electric can opener of the embodiment of the present invention;

FIG. 7b is a bottom view of the main gear of the electric can opener of the embodiment of the present invention;

FIG. 8 is a top exploded perspective view of the blade assembly of the electric can opener of the embodiment of the present invention;

FIG. 9 is a bottom exploded perspective view of the blade assembly of the electric can opener of the embodiment of the present invention;

FIGS. 10 and 11 are perspective and top views respectively, showing the relationship between the elastic member and the rotatable shaft at the ready position;

FIG. 12 is a bottom view showing the rotatable shaft at the ready position;

FIGS. 13 and 14 are perspective and top views respectively, showing the relationship between the elastic member and the rotatable shaft at the operating position; and

FIG. 15 is a bottom view showing the rotatable shaft at the ready position.

### DETAILED DESCRIPTION OF THE INVENTION

First of all, it is to be mentioned that the technical features provided by the present invention are unlimited to the specific structure, usage and application thereof described in the detailed description of the invention. It should be understood by those skilled in the related art that all the terms used in the content of the specification are for illustrative description. The directional terms mentioned in this specification, such as ‘front’, ‘upper’, ‘lower’, ‘rear’, ‘left’, ‘right’, ‘top’, ‘bottom’, ‘inside’, and ‘outside’, are also just for illustrative description on the basis of normal usage direction, not intended to limit the claimed scope.

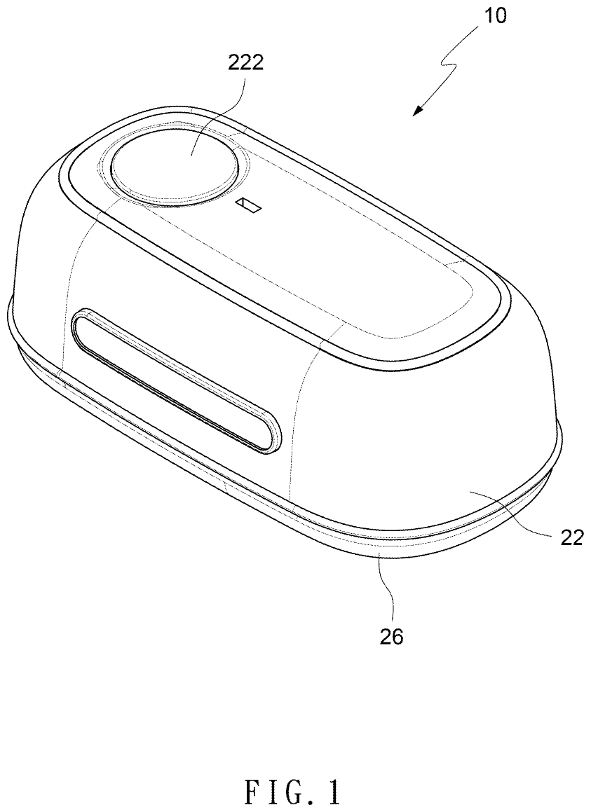

Referring to FIGS. 1 to 3, an electric can opener 10 provided in accordance with a preferred embodiment of the present invention is mainly composed of a housing 20, a transmission structure 30 installed in the housing 20, and a can cutting structure 40.

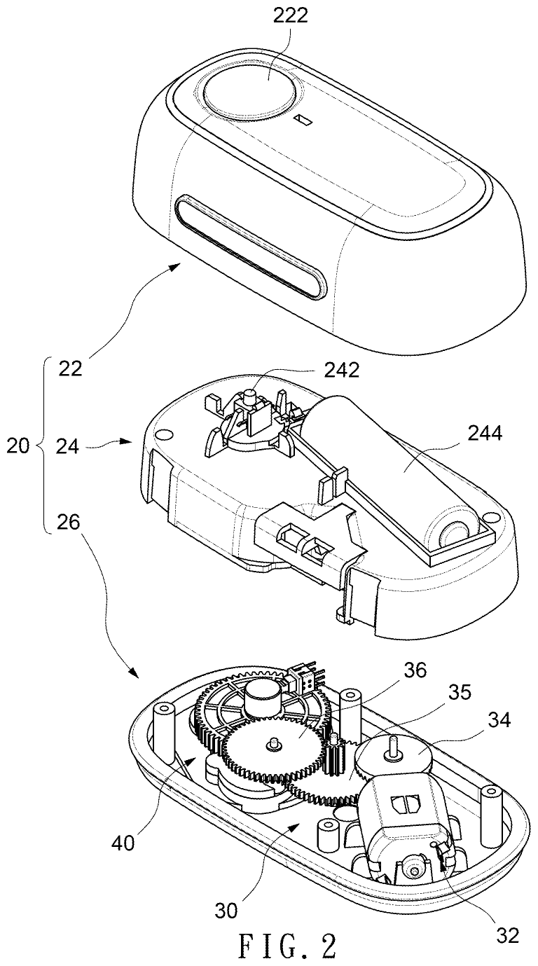

As shown in FIG. 2, the housing 20 includes a top shell 22, a partition plate 24, and a bottom shell 26. The partition plate 24 is fixedly disposed in an internal space formed by the top shell 22 and the bottom shell 26. A top surface of the top shell 22 is equipped with a push button 222, and a top portion of the partition plate 24 is equipped with a main power switch 242 and a battery 244 electrically connected to the main power switch 242. The main power switch 242 corresponds to and is located below the push button 222. By pressing the push button 222, the main power switch 242 is activated, thereby providing the electric power from the battery 244 to start the electric can opener 10. Pressing the push button 222 again will cut off the power.

Referring to FIGS. 2 to 5, the bottom shell 26 accommodates the transmission structure 30 and the can cutting structure 40 therein. The transmission structure 30 is installed at a top portion of the bottom shell 26, and the can cutting structure 40 has some components located at the top portion of the bottom shell 26, while some components are exposed outside the bottom shell 26 (details will be given below). The bottom shell 26 has a bottom plate 261, an elongated slot 262 penetrating through top and bottom surfaces of the bottom plate 261, four positioning pillars 263 located on the top surface of the bottom plate 261 and distributed around the elongated slot 262, four positioning holes 264 located on the top surface of the bottom plate 261 and distributed around the elongated slot 262 and the positioning pillars 263, an engagement pillar 265 with a cut surface located on the top surface of the bottom plate 261, and an installation recess 266 provided on the bottom surface of the bottom plate 261. One of the four positioning holes 264 penetrates through the top and bottom surfaces of the bottom plate 261 to serve as a working hole 267. In addition, a magnet 268 is embedded in the middle portion of the bottom plate 261 to attract the top surface of a can.

The transmission structure 30 includes a motor 32 electrically connected to the battery 244 and a reduction gear set engaged with the output shaft (not shown) of the motor 32. In this embodiment, the reduction gear set includes three reduction gears 34, 35, and 36. These reduction gears 34, 35, and 36 are respectively rotatably installed on the top surface of the bottom plate 261 at specific positions by their central axles and meshed with each other in sequence. The sizes and tooth numbers of these reduction gears 34, 35, and 36 are specially designed to transmit the output power of the motor 32 in a low-speed and high-torque manner. As this transmission structure 30 is similar to conventional ones and is not the main technical feature of the present invention, it will not be necessarily described in detail here.

The main technical feature of the electric can opener 10 provided by the present invention lies in the collaborative design of the can cutting structure 40 with the bottom shell 26. Specifically, the can cutting structure 40 includes a rotatable shaft 42, an elastic member 44, a roller mounting plate 46, a main gear 48, a power-off switch 54, a blade mounting plate 56, a blade assembly 58, a guard plate 76, and an engaging gear 78.

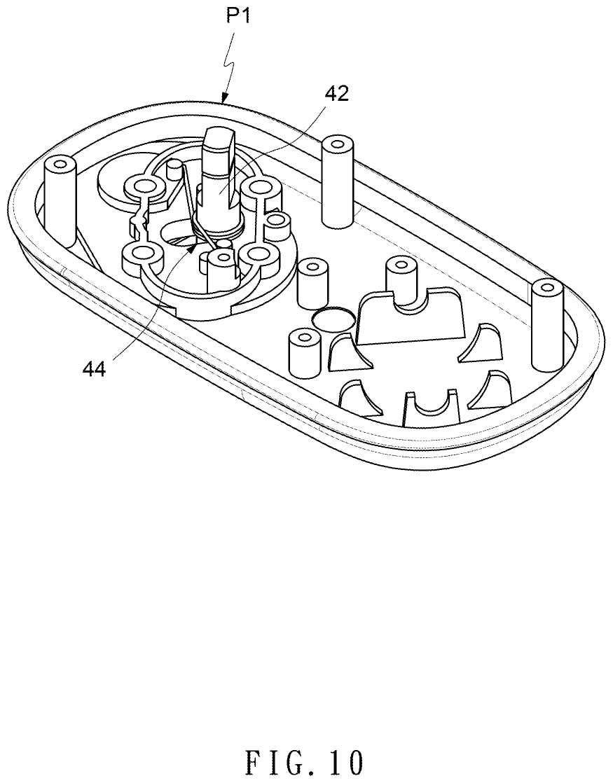

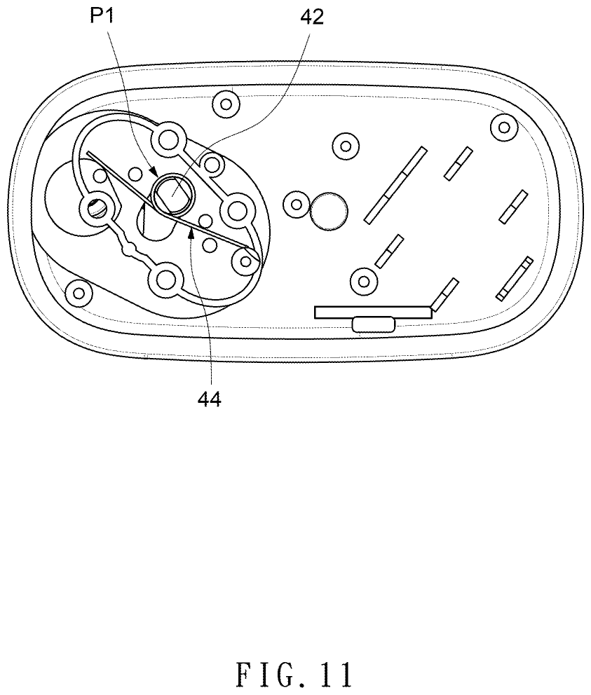

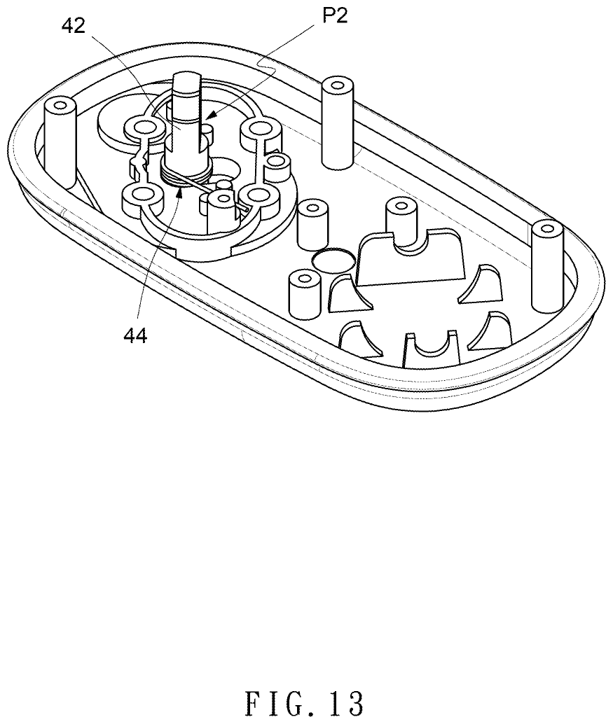

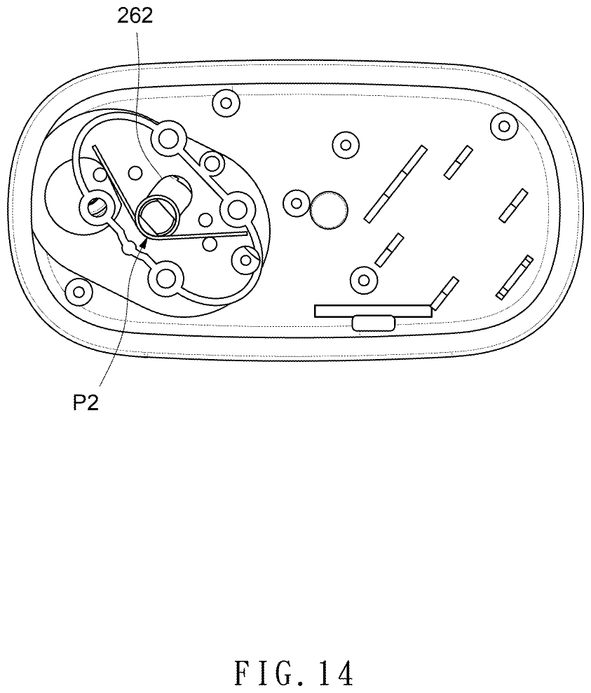

Referring to FIGS. 2 to 5 again, the rotatable shaft 42 has a cylindrical body portion 422, a top end portion 424 with a non-circular cross-section, and a bottom end portion 426 with a non-circular cross-section. In assembly, the rotatable shaft 42 is inserted through the elongated slot 262 and reciprocally moveable along the elongated slot 262 between a ready position P1 (as shown in FIGS. 10 and 11, i.e., one end of the elongated slot 262) and an operating position P2 (as shown in FIGS. 13 and 14, i.e., the other end of the elongated slot 262). At this time, the top end portion 424 is located inside the bottom shell 26, and the bottom end portion 426 protrudes outside the bottom shell 26.

Regarding the elastic member 44, in this embodiment, it is realized as a torsion spring, but the present invention is not limited to this design. The elastic member 44 is located at the top portion of the bottom shell 26 in a way that a central coil 442 of the elastic member 44 is sleeved onto the body portion 422 of the rotatable shaft 42, and two support legs 444 are abutted against two positioning pillars 263. Thus, the elastic member 44 imparts a rebounding force on the rotatable shaft 42 for moving the rotatable shaft 42 toward the ready position P1.

As for the roller mounting plate 46, four positioning pillars 462 extending downwardly from a bottom surface of the roller mounting plate 46 are provided. In assembly, the roller mounting plate 46 is fixed to the top surface of the bottom plate 261 by inserting the positioning pillars 462 into the positioning holes 264, such that the roller mounting plate 46 is fixedly disposed inside the bottom shell 26. Furthermore, the roller mounting plate 46 has a through hole 464 in communication with the elongated slot 262 of the bottom plate 261 for the rotatable shaft 42 to pass through. Additionally, the top surface of the roller mounting plate 46 is equipped with a roller 466. For the roller 466, a rotary wheel or a bearing may be used in this embodiment. Moreover, one side of the roller mounting plate 46 has an engagement hole 468. In assembly, the engagement hole 468 is engaged with the engagement pillar 265, facilitating quick alignment and assembly of the roller mounting plate 46.

Concerning the main gear 48, it includes a circular gear member 482, a cam 484 monolithically formed with the circular gear member 482 and protruding downward from the bottom surface of the circular gear member 482, and an axial hole 486 penetrating through both the circular gear member 482 and the cam 484. In assembly, the axial hole 486 is coaxially fitted onto the top end portion 424 of the rotatable shaft 42, and then the main gear 48 is fixed to the top end portion 424 of the rotatable shaft 42 by a C-shaped retainer 50 that is fixed to the top end portion 424. Thereafter, a cylindrical shaft cover 52 is capped onto the top end portion 4242 of the rotatable shaft 42. At this point, the circular gear member 482 is meshed with the reduction gear 36 of the transmission structure 30. Therefore, the motor 32 can drive the main gear 48 to rotate through the reduction gears 34, 35, and 36. Specifically, the cam 484 has substantially an elliptical profile and is formed by a plurality of ribs protruding from the bottom surface of the circular gear member 482 in such a way that the can 484 has a long axis and a short axis, and the axis of the axial hole 486 passes through the center of the circular gear member 482 and is biased towards one side of the short axis. As a result, an outer periphery of the cam 484 serves as a contact surface 488. This contact surface 488 is in rolling contact with the roller 466, and the distance between the contact surface 488 and the axis of the rotatable shaft 42 will vary in accordance with the contacting locations on the contact surface 488. When the rotatable shaft 42 is in the ready position P1 and the main gear 48 is driven to rotate by the motor 32, because the axial of the roller 466 is fixed to the roller mounting plate 46 and thus stays stationary, and the roller 466 is in rolling contact with the contact surface 488, the distance between the axis of the rotatable shaft 42 and the axis of the roller 466 will change in accordance with the rolling contact locations on the contact surface 488. As a result, the rotatable shaft 42 will be pushed due to the cam effect from the ready position P1 to the operating position P2 along the elongated slot 262.

Regarding the power-off switch 54, it is electrically connected to the battery 244 and is located by one side of the rotatable shaft 42. Specifically, it is located at a location corresponding to the shaft cover 52. As such, when the rotatable shaft 42 moves from the operating position P2 to return to the ready position P1, the rotatable shaft 42 will contact the power-off switch through the arc-shaped outer peripheral surface of the shaft cover 52, triggering the power-off switch 54 and thereby cutting off the power supplied to the electric can opener 10.

Regarding the blade mounting plate 56, it is a hard plastic or metal plate with a shape matching the installation recess 266 of the bottom plate 261. It is fixed in the installation recess 266 by adhesive or other fixing methods such as locking. The blade mounting plate 56 has a top surface 561, a bottom surface 563, an elongated slot 565 that penetrates through the top surface 561 and the bottom surface 563 and is in communication with the elongated slot 262 of the bottom plate 261, and a through hole 567 that penetrates through the top surface 561 and the bottom surface 563 and is in communication with the working hole 267. In this way, the rotatable shaft 42 passes through both the elongated slot 262 of the bottom plate 261 and the elongated slot 565 of the blade mounting plate 56.

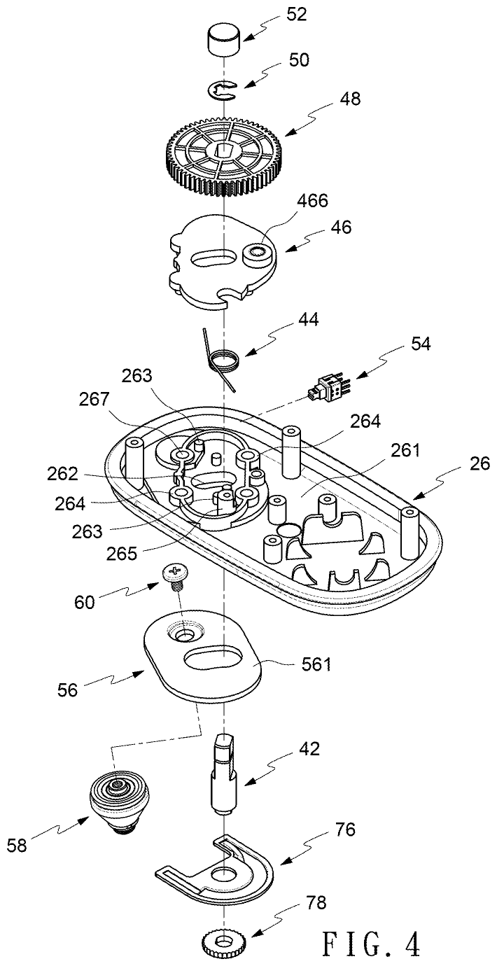

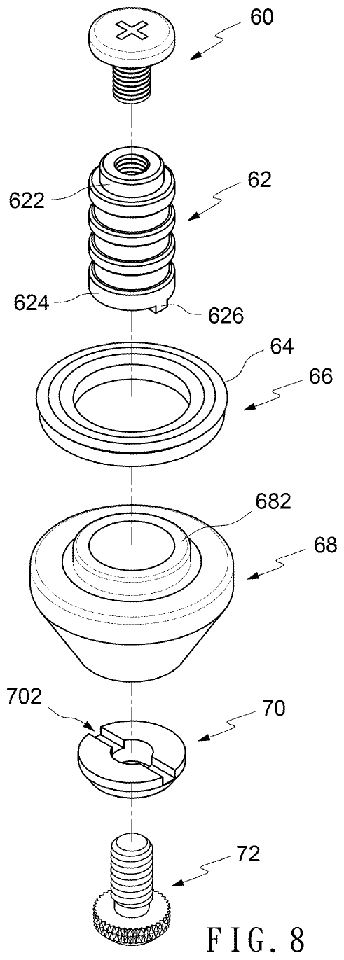

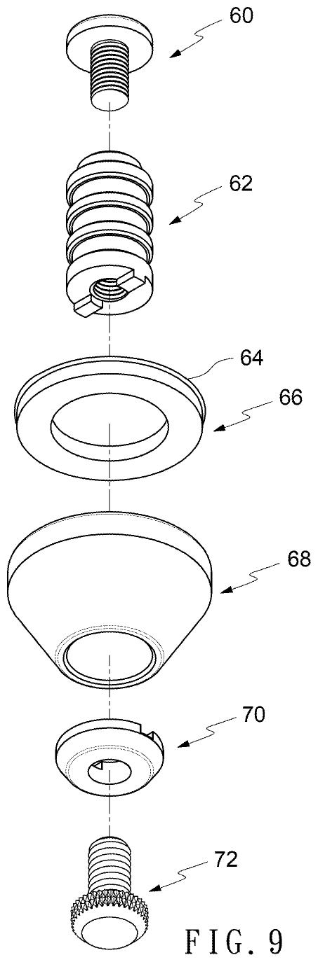

Referring to FIGS. 4, 5, 8, and 9, the blade assembly 58 includes a top screw 60, a central axle 62, a ring blade 66 with a ring blade edge 64, a conical sleeve 68, a washer 70, and a bottom screw 72. The central axle 62 has a top end portion 622, a bottom end portion 624, and an engagement block 626 located at the bottom end portion 624. In assembly, the top end portion 622 of the central axle 62 is inserted into the through hole 567 of the blade mounting plate 56, and the top screw 60 is screwingly threaded into the top end portion 622 of the central axle 62 and pressed against the top surface 561 of the blade mounting plate 56, thereby fixing the central axle 62 to the blade mounting plate 56. In this way, the central axle 62 is indirectly fixed to the bottom plate 261 of the bottom shell 26 via the blade mounting plate 56, and the bottom end portion 624 of the central axle 62 protrudes outside the bottom plate 261 of the bottom shell 26. Additionally, the conical sleeve 68 is a conical tubular body with a larger top and a smaller bottom. The sleeve 68 has a top portion provided with a central protruding shaft 682. With this structural feature, the ring blade 66 can be first sleeved onto the central protruding shaft 682, and then the ring blade 66, the sleeve 68, and the washer 70 are successively sleeved onto the central axle 62 from the bottom end portion 624 towards the top end portion 622 of the central axle 62 in such a way that the engagement block 626 of the central axle 62 is engaged with the engagement groove 702 of the washer 70. Finally, the bottom screw 72 is screwingly threaded into the bottom end portion 624 of the central axle 62 to tighten up the conical sleeve 68 via the washer 70, thereby completing the assembly of the entire blade assembly 58. In this way, the ring blade 66 is firmly and positively sandwiched between the top surface of the sleeve 68 and the bottom surface 563 of the blade mounting plate 56.

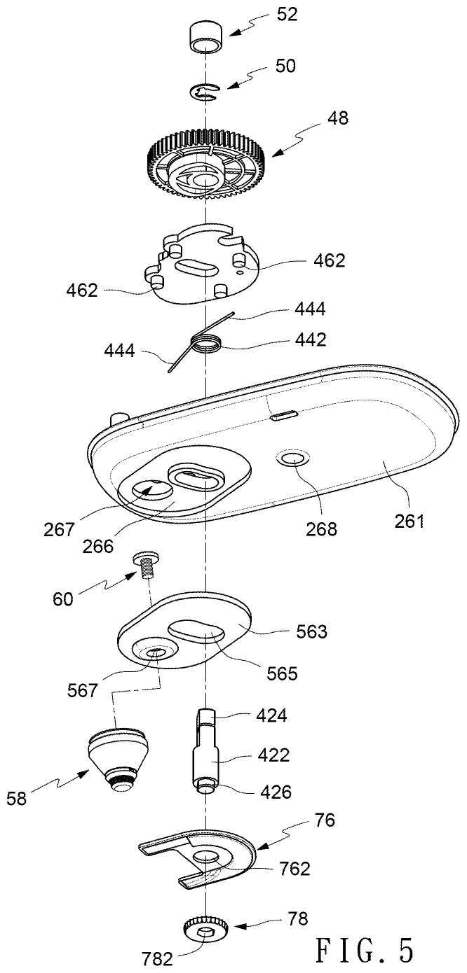

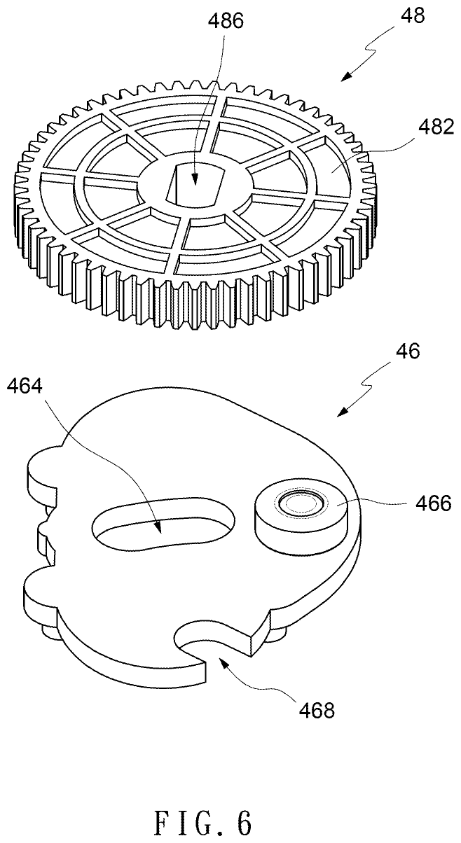

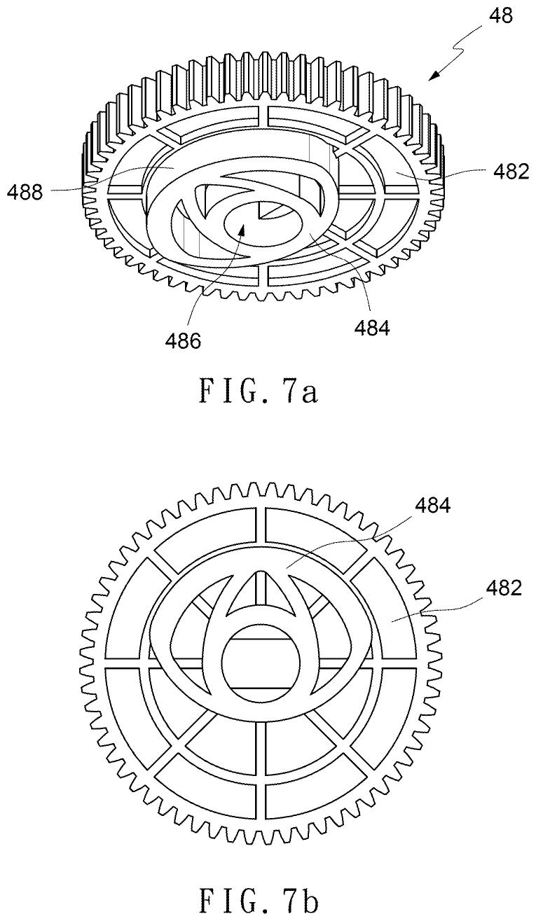

Referring to FIGS. 4 and 5, the guard plate 76 is a metal plate with a through hole 762. In assembly, the through hole 762 is sleeved onto the body portion 422 of the rotatable shaft 42, allowing the guard plate 76 to abut to the blade mounting plate 56 and shielding the elongated slot 565 of the blade mounting plate 56. In this way, the guard plate 76 can withstand friction from the can's edge, thereby protecting the blade mounting plate 56 from damage.

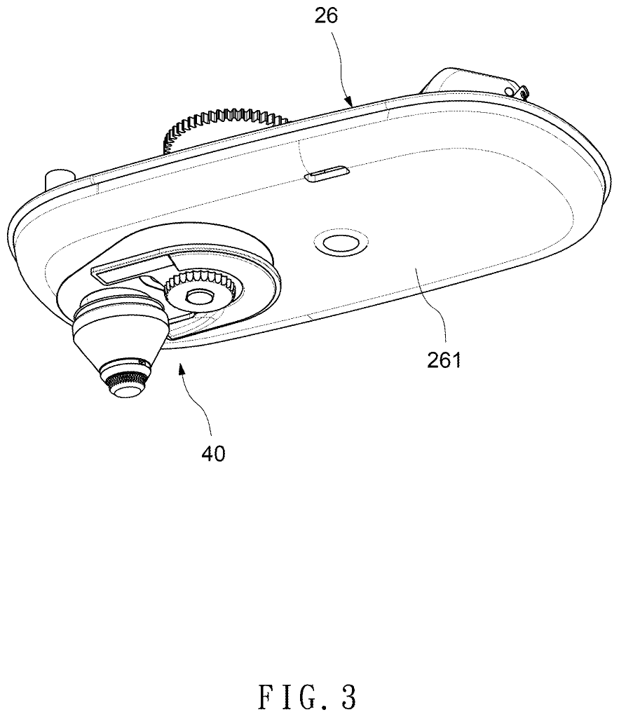

Referring to FIGS. 3 to 5, the engaging gear 78 has a non-circular mounting hole 782. In assembly, the mounting hole 782 is tight fitted onto the bottom end portion 426 of the rotatable shaft 42 and can be fixed to the bottom end portion 426 of the rotatable shaft 42 by any suitable fixing methods such as welding, fixing screws, or tight fits. The engaging gear 78 has sharp tooth tips that can engage with the inner periphery of the top portion of the can under cut.

The above describes the structural features and assembly methods of the various components of the electric can opener 10 provided by an embodiment of the present invention. The following will explain the operating method and function of the electric can opener 10.

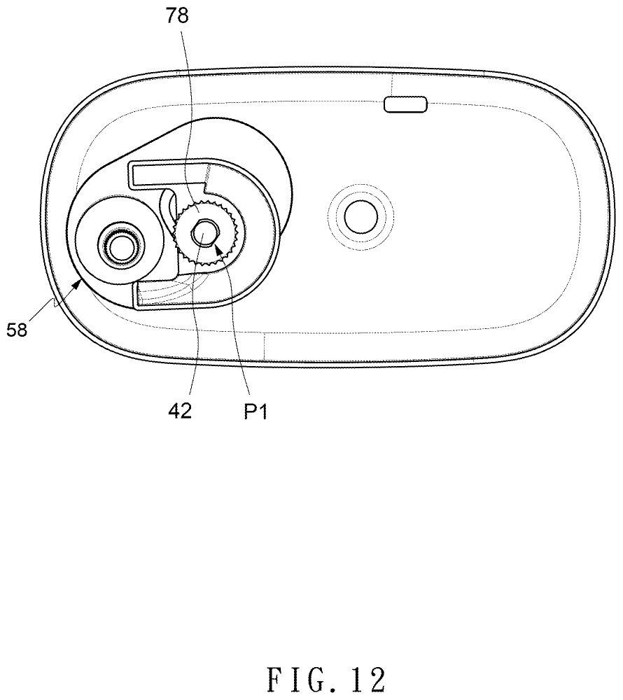

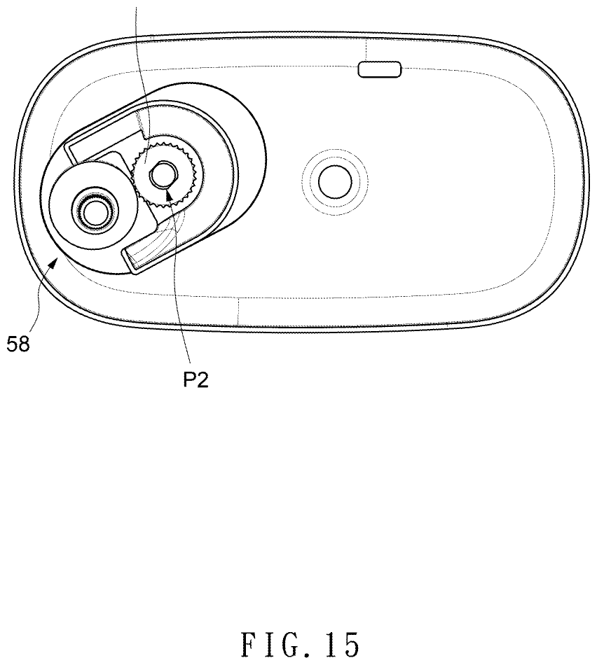

FIGS. 2 and 10 to 12 show the state where the rotatable shaft 42 is in the ready position P1. At this time, the engaging gear 78 is away from the blade assembly 58. This allows the electric can opener 10 to be placed on the top edge of the can under cut in such a way that the top edge of the can under cut is positioned between the engaging gear 78 and the blade edge 64. Thereafter, pressing the push button 222 will start the motor 32 to drive the main gear 48 to rotate. By means of the design of rolling contact between the roller 466 and the cam 484, the rotatable shaft 42 is forced to slide from the ready position P1 towards the operating position P2. During this movement, the gap between the engaging gear 78 and the blade edge 64 gradually decreases until the engaging gear 78 engages with the inner side of the top edge of the can under cut, and the blade edge 64 cuts into the cylindrical body of the can under cut, such that the rotatable shaft 42 is eventually stopped at the aforementioned operating position P2, as shown in FIGS. 13-15. At this point, although the elastic member 44 is tensioned, the rebounding force of the elastic member 44 will be smaller than the engaging force provided by the engaging gear 78, preventing the rotatable shaft 42 from returning. Consequently, the main gear 48 will continue to rotate, driving the engaging gear 78 in cooperation with the blade assembly 58 to perform a circular motion along the top edge of the can, allowing the blade edge 64 to completely cut open the can. After the can is completely opened, as there is no longer a reactive force from the blade edge 64 cutting into the can, the engaging force of the engaging gear 78 becomes smaller than the rebounding force of the elastic member 44. As a result, the rebounding force will push the rotatable shaft 42 to move from the operating position P2 back to the ready position P1. At this moment, the rotatable shaft 42 will press the power-off switch 54 through the shaft cover 52, thereby cutting off the power supplied to the electric can opener 10 and thus completing the entire can-opening process.

From the above description, it can be understood that the electric can opener 10 of the present invention, which has the main gear 48 monolithically provided with the cam 484, has a simpler structural design for the can cutting structure 40 compared to prior arts, resulting in ease in manufacturing and assembly and high convenience in use. Furthermore, by simply loosening the bottom screw 72, the sleeve 68 and the ring blade 66 can be sequentially removed from the central axle 62 for replacing a new ring blade, achieving the advantages of ease and convenience in assembly, disassembly and replacement of the entire blade assembly 58 so as to achieve the objectives of the present invention.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An electric can opener, comprising:
a bottom shell having a bottom plate and an elongated slot penetrating through the bottom plate;
a rotatable shaft having a top end portion and a bottom end portion, the rotatable shaft being inserted through the elongated slot in a way that the rotatable shaft is reciprocally moveable along the elongated slot between a ready position and an operating position, the top end portion is located inside the bottom shell, and the bottom end portion protrudes outside the bottom shell;
a main gear coaxially mounted to the top end portion of the rotatable shaft and drivenable to rotate, the main gear having a bottom surface monolithically formed with a cam having a contact surface in a way that a distance between the contact surface and an axis of the rotatable shaft varies in accordance with locations of the contact surface;
a roller rotatably disposed inside the bottom shell in contact with the contact surface of the cam;
an engaging gear fixed to the bottom end portion of the rotatable shaft;
a blade assembly directly or indirectly disposed to the bottom shell and provided with a blade edge outside the bottom shell; and
an elastic member connected with the rotatable shaft to impart a rebounding force on the rotatable shaft for moving the rotatable shaft toward the ready position;
wherein when the rotatable shaft stays at the ready position, the engaging gear is away from the blade assembly, and when the rotatable shaft stays at the operating position, the engaging gear is close to the blade assembly for clamping a can between the blade edge and the engaging gear.

2. The electric can opener of claim 1, wherein the main gear comprises a circular gear member, the cam monolithically formed with the circular gear member, and an axial hole penetrating through the circular gear member and the cam; the top end portion of the rotatable shaft is fixedly inserted into the axial hole; the cam has an elliptical profile with a long axis and a short axis; the axial hole has an axis passing through a center of the circular gear member and is biased towards one side of the short axis.

3. The electric can opener of claim 2, wherein the cam is formed by a plurality of ribs protruding from a bottom surface of the circular gear member.

4. The electric can opener of claim 1, further comprising a roller mounting plate fixed inside the bottom shell and located between the bottom plate and the main gear; the roller mounting plate has a through hole in communication with the elongated slot of the bottom plate for the rotatable shaft to pass through; the roller is disposed on a top surface of the roller mounting plate.

5. The electric can opener of claim 1, further comprises a power-off switch located by one side of the rotatable shaft in a way that when the rotatable shaft moves from the operating position to the ready position, the rotatable shaft contacts the power-off switch for cutting off a power supplied to the electric can opener.

6. The electric can opener of claim 1, wherein the blade assembly comprises a central axle, a ring blade with the blade edge, a sleeve, and a bottom screw; the central axle has a top end portion directly or indirectly fixed to the bottom plate of the bottom shell, and a bottom end portion protruding outside the bottom plate of the bottom shell; the ring blade and the sleeve are sequentially sleeved onto the central axle from the bottom end portion of the central axle towards the top end portion of the central axle; the bottom screw is screwingly threaded into the bottom end portion of the central axle to tighten up the sleeve.

7. The electric can opener of claim 6, wherein the bottom plate of the bottom shell has a bottom surface provided with an installation recess; the electric can opener further comprises a blade mounting plate fixedly disposed to the installation recess and provided with a top surface, a bottom surface, an elongated slot corresponding to and communicating with the elongated slot of the bottom plate, and a through hole penetrating through the top and bottom surfaces of the blade mounting plate; the top end portion of the central axle is inserted into the through hole of the blade mounting plate and fixed to the blade mounting plate by a top screw that is screwingly threaded into the top end portion of the central axle and presses against the top surface of the blade mounting plate.

8. The electric can opener of claim 7, wherein the bottom shell has a working hole penetrating through the bottom plate in a way that the working hole is in communication with the through hole of the blade mounting plate.

9. The electric can opener of claim 7, wherein the sleeve is provided at a top portion thereof with a central protruding shaft; the ring blade is sleeved onto the central protruding shaft and sandwiched between a top surface of the sleeve and the bottom surface of the blade mounting plate.

10. The electric can opener of claim 6, wherein the blade assembly further comprises a washer sleeved onto the central axle and sandwiched between the bottom screw and the sleeve; the washer has an engagement groove, and the bottom end portion of the central axle has an engagement block engaged in the engagement groove.
